(19) United States
(12) Patent Application Publication
(10) Pub. No.: US 2003/0217186 A1
(43) Pub. Date: Nov. 20, 2003

(54) Apparatus for and method of seamless wireless multimedia download path to peer networked appliances

(76) Inventor: Robert D. Bushey, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/147,000

(22) Filed: May 16, 2002

(51) Int. Cl. G06F 15/16

(52) U.S. Cl. 709/250; 709/228

(57) ABSTRACT

The present invention encompasses a system and method in which networked appliances communicate with each other over a local area network as equals without the requirement of a supervising personal computer. The invention incorporates communication capabilities within each of the networked appliances and unique identifiers and enables the appliances themselves to communicate and exchange data, and access a wide area network such as the Internet. The networked appliances communicate with each others as peers rather than through a personal computer or central server. A network appliance of the present invention includes a memory, a data interface to a local area network and a controller. The included controller is dedicated to execute an application specific routine that processes data located in the memory, execute a network interface routine to interface to the local area network and identify a type and an address of at least one dedicated data device and exchange data between the memory of the network appliance and the dedicated data device.

### TECHNICAL FIELD

The present invention generally relates to communications between digital devices and more specifically to data communications to network and data transfer between and among digital and/or Internet appliances and networks.

### BACKGROUND OF THE INVENTION

Today communications and data transfer between electronic platforms, including personal digital assistants (PDA), personal computers, printers, scanners, facsimile machines, and handheld computers are typically accomplished via point to point communications using direct connections between the corresponding devices or by transferring the data via a storage device such as a diskette, compact disc or tape. Point to point communications means the communication is performed from one device to a second device, typically a personal computer. In addition to the actual electrical connections between corresponding computer devices, to enable transfer of information therebetween, computer operating instructions or a program must also be available to effectuate and/or monitor establishment of a requisite physical or virtual connection and/or subsequent data transfer. These computer operating instructions are typically included in a software program stored by and executed by the system used to effectuate the transfer. Therefore, prior systems used to support the data transfer between devices typically include a personal computer; e.g. specialized software on a personal computer enables and monitors the data transfer process.

A home computing environment typically starts out when a user purchases a personal computer along with its display and keyboard. In addition the user may purchase peripheral devices such as a printer, a scanner, a tape drive, a modem, a digital camera and other similar devices. Each of these peripheral devices must be connected either temporarily or permanently to the personal computer for data exchange and software support. In addition to a physical connection to the personal computer, each of these peripheral devices typically requires specialized software which resides on the personal computer and/or on the peripheral device which enables the peripheral device to properly interface with the personal computer for the transfer of control and data messages therebetween. This interface software may consist of device drivers, programs which ensure compatibility between the operating system running on the personal computer and the software resident on the peripheral device, programs necessary for data transfer and similar programs. Device drivers or interface software typically come with the operating system of the computer or are supplied separately on a diskette or CD with the peripheral device or over a communications network. While personal computer supplies typically include some standard drivers with bundled software (e.g., operating system), users rely on the peripheral supplier to provide drivers for less common devices and for driver updates.

Adding or upgrading peripheral devices on a personal computer often involves a sequence of steps including: identifying a need for the peripheral device, acquiring the peripheral device, identifying the device driver or interface software required to add the peripheral device to the computer system, reading the installation instructions, “readme” file or directives, configuring the software to allow the peripheral device to be attached to the personal computer, and ensuring that conflicts do not exist or resolving such conflicts between device drivers or other system resources. This process is complex, involved, and error prone.

Similarly, software does not remain static. As new peripheral features are identified, coded, tested and shipped, device driver programs or other software programs evolve. Inadvertent problems included in software also need to be corrected and eliminated which requires consumer access to updated software. When a device driver is updated, problems may arise when the updated driver conflicts with another device driver already included on the system for a separate peripheral device. A typical consumer may spend an inordinate amount of time in trying to resolve these conflicts only to have their efforts frustrated by unforseen incompatibilities.

In addition to the physical connections between devices and the transfer media, wireless communications may occur between the computer system and peripherals. One type of wireless transfers include orienting an infrared window of the peripheral device so that it generally faces the infrared window of the personal computer, initiating a program on either the personal computer or the peripheral device to establish communications with the corresponding component and, once the interface is established, instructing a component on the system to perform steps or provide a user requested function. For the average consumer, this wireless communication between devices is fraught with problems and it is not uncommon for the typical consumer to have their efforts frustrated before the systems have been linked and synchronized.

Additionally each of these prior art systems described typically include point to point messaging between a peripheral and the personal computer or between two peripherals under control of the personal computer, i.e., a “pc-centric” architecture wherein a personal computer or server is the hub for all data transactions. For instance if a user wishes to store digital images residing on a digital camera on a tape drive, the user would attach the digital camera to the personal computer and use the personal computer to transfer the digital images from the camera to the tape drive, the entire process being orchestrated by the personal computer.

### BRIEF SUMMARY OF THE INVENTION

The invention includes a network appliance having a memory, a data interface to a local area network and a controller. The memory is configured to store an application specific routine. The controller is dedicated to execute an application specific routine to process data in its memory and a network interface routine to interface with the local area network. The network interface routine uses the data interface and identifies a type and address of a dedicated data device resident on the local area network. The controller is further configured to exchange data between the memory and the dedicated data device.

### BRIEF DESCRIPTION OF THE DRAWINGS

FIG. 1 illustrates a block diagram of a group of peer networked appliances included in a system according to an embodiment of the invention;

FIG. 2 illustrates a block diagram of various methods in which software resident on a network appliance may be updated according to an embodiment of the invention; and

FIG. 3 is a block diagram of a network appliance interfaced to a plurality of dedicated data devices over a local area network according to an embodiment of the invention.

### DETAILED DESCRIPTION OF THE INVENTION

In view of the rapid proliferation of a broad range of general use and specialized data processing devices, and, in particular, information and/or data appliances a need exists for an automatic, error free communications device and method which will coordinate and accomplish the transfer of driver and related software between corresponding devices. This need includes the ability for a peripheral device to transfer data directly to the personal computer, or to any other peripheral on a network. A further need exists for the communications device or the methodology to occur automatically without requiring the owner's knowledgeable participation in and control over the process. A further need exists for a communications device and methodology to query, identify, locate, download and update device driver or other communication software, when enabled by the user, without the active participation by the owner. A further need exists to incorporate the knowledge required to perform a data transfer and update of information to the device requiring the update. A further need exists to broaden the platforms available to enable communications to include any device which will allow peripherals to update information without requiring use of a personal computer.

The needs identified in the prior paragraph and additional features and technical advantages are achieved by a system and method including a network appliance, device or other peripheral device, which selectively communicates with one or more dedicated data devices that are resident on a local area network. The network appliance includes a memory which may be electrically connected to a data interface which allows communication with the local area network and a controller which is dedicated to execute an application-specific routine to process data in the memory. The controller also executes a network interface routine to interface with the local area network using the data interface and identify a type and address of at least one of the dedicated data devices, and exchange data between the memory and at least one of the dedicated data devices. A device according to the invention may also include a transducer which is responsive to an external stimulus (e.g., an image) for storing data relating to a characteristic of the stimulus (e.g., light values) into the memory. The controller may be configured or dedicated to upload the data to at least one of the dedicated data devices. The transducer may also include an image sensor (e.g., a digital camera), an acoustic sensor (e.g., microphone) and/or a specialized electronic media reader (e.g., MP3 player). A device according to the invention may also include an output device which is configured to receive the data from the memory where the controller is configured to download the data from at least one of the dedicated data devices. The output device may be a printer, a video display, an audio output device, and/or an interface to a remote network such as a gateway to the Internet. The controller of the present invention may be an application-specific integrated circuit (ASIC) and the data interface may be a wireless data transceiver which transmits and receives using a radio frequency (RF) or an infrared (IR) communication link. The network appliance may also include a display configured to provide an indication of the dedicated data devices, (e.g., list of compatible devices found on the network) and an input device configured to provide for a manual selection to initiate a data transfer with the dedicated data devices, (e.g., load MPEG video from a camcorder onto a network video server). The network appliance may further include an application-specific operating system stored in the memory, where the controller further executes the application-specific operating system. The network appliance may also include a protocol conversion routine for converting between a first data format corresponding to a native data format of the network appliance and a second data format corresponding to a native data format of the target (or source) dedicated data devices.

Another embodiment of the present invention may include a system in the form of a network of appliances, including a communications network between a number of network appliances. Each network appliance may include a data interface with the local area network and a controller dedicated to execute an application-specific routine to process data. The controller may execute a network interface routine to interface with the local area network using the data interface and identify a type and address of at least another one of the network appliances on the communications network, and exchange the data with the other network appliance over the communications network. The system of network appliances may include a communications network which comprises a wireless local area network and the data interfaces may comprise wireless data transceivers. The system of network appliances may be a first group of data supplying network appliances which have a dedicated input device configured to receive information from some external media or source and a second group of data receiving network appliances each having a dedicated output device configured to generate a representation of the data onto an output media. Each of the network appliances may also include a protocol conversion routine for converting between a first data format corresponding to a native data format of each network appliance and a second data format corresponding to another one of the network appliances.

A method according to an embodiment of the present invention may include the steps of transferring data between first and second network appliances which may include one or more of the steps of establishing communications with a local area network, registering with the local area network, identifying resources available on the local area network, identifying resources on the network which satisfy predetermined compatibility criteria; establishing communications with the identified resources satisfying the predetermined compatibility criteria, and exchanging data with the selected resource. This embodiment may further include steps of displaying the resources satisfying the predetermined compatibility criteria and selecting a specific resources from the display. An additional step of identifying a data format of the selected resource and converting between a different data format and the data format of the selected resource may also be included. The step of establishing communications may include steps of creating a wireless communications link between the first network appliance and the local area network and creating a wireless communications link between the local area network and the second network appliance.

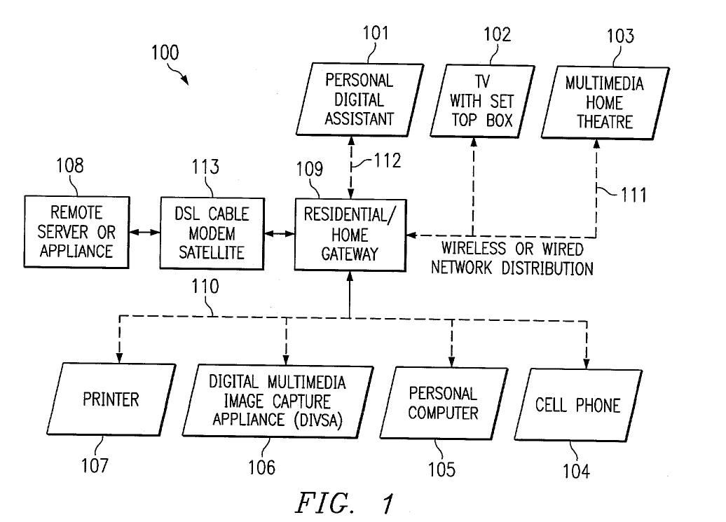

FIG. 1 is a block diagram of a group of peer networked appliances, devices, or peripheral devices, hereinafter collectively referred to as networked appliances, included in a system 100 which enables communication between the individual network appliances without participation of a personal computer. A peer networked appliance may be an appliance which connects to a network as depicted in FIG. 1. Networked appliances can also be called informational appliances. In FIG. 1, Personal Digital Assistant (PDA) 101, TV with set top box 102, multimedia home theatre 103, cell phone 104, personal computer 105, digital multimedia image capture appliance 106 and printer 107 all may be networked appliances, each having the capability to identify other compatible appliances and establish communications therewith for, inter alia, the transfer of data therebetween. PDA type networked appliance 101 may contain all of the traditional features of a conventional PDA, and further include a capability to directly transfer data to another networked appliance. For example, PDA 101 may transfer data directly to printer 107 without having the transfer of data initiated by or otherwise involve a personal computer (except that the PC itself may act as a peer networked appliance). Many other types of networked appliances can also be envisioned.

Television 102 may transfer individual frames of data directly to printer 107 and allow the user to print images directly from the TV broadcast. Full motion video images displayed on multimedia home theatre 103 can also be generated by printer 107 or stored on Digital Multimedia Image Capture Appliance (DiVSA) 106 for later enjoyment. It should be understood that a memory or other storage or data device may be accessed similarly. Cell phone 104 includes the capability to transfer data to other peer network devices and allows the automatic download of phone numbers or other information available from storage devices resident on or accessible via the local home network.

Personal computer 105, rather than being a focal point of all data exchanges between and among peer network appliances, is instead relegated to function as any other networked appliance in that it can communicate as an equal with any other networked appliance on the network and can download information or exchange data.

Residential/Home Gateway 109 allows the home local area net (LAN) to connect to a remote network and resources and to access a wide area network (WAN) or the Internet. This connection to remote resources and communications networks typically occurs through remote server or appliance 108 and occurs over one or more communication links 113 which may be, for example, one or more of the following: a DSL line, a cable, infrared communications, radio frequency (RF) link, telephone or satellite communications link. These peer to peer networked appliances may communicate via an advanced peer to peer network topology.

As further shown in FIG. 1, PDA 101 may directly interface to Residential/Home Gateway 109 to access remote server 108 via DSL 113 and wireless link 112. Similarly, TV 102 or Home Theatre 103 may use wireless link 111 to access Residential/Home Gateway 109. Wireless link 112 may be RF such as Bluetooth, HomeRF, etc.; infrared (IR); or any other point-to-point or point-to-multipoint capable media. While a wireless connection between the networked appliances is described, note that a wired network would be encompassed by the current invention.

Each of the networked appliances on system 100 includes an embedded operating system which is typically dedicated to the main function of the appliance. In addition each of the networked appliances on system 100 also may include communication hardware and software which allows the networked appliance to directly communicate with other networked appliances. Each of the networked appliances may include a unique identifier and/or network address and appliance type data which enables other appliances on the network to recognize a specific network appliance when communications is established with the specific appliance and to determine compatibility and requirements therewith. Additionally, a protocol conversion routine may be included to allow network appliances to communicate with each other.

Network appliances may be added to or removed from system 100. Individual network appliances may be added to system 100 by locating the individual network appliance within communications range of system 100 and adding the individual network appliance through a discovery process. The discovery process may be initiated from the individual network appliance, either automatically upon establishment of communications with the network, or manually by the depression of an initialize button or similar feature on the appliance being added to system 100. When the initialize button is depressed the individual appliance may seek out and identify other network appliances accessible via and/or resident on the network and their unique identifiers. During initialization, the other network appliances currently included in system 100 may also acquire data from the appliance being introduced into the system including the device type and a unique identifier for and/or address of the newly added device. Unique identifiers may be generated when the individual appliance is introduced to system 100 or may be assigned to appliances by the manufacturer before the appliance is delivered to the consumer. Similar techniques for adding updated information to the memories of all appliances in system 100 are also within the scope of the present invention.

Alternatively, individual appliances may be removed from system 100 by activation of a button on the removed appliance which, upon activation notifies the other networked appliances of system 100 of the removal of the specified device from system 100. Once the appliance being removed from system 100 receives an acknowledge from the other appliances in system 100, the removed appliance may remove from its memory information pertaining to system 100 or the networked appliances resident in system 100. Similar techniques for removing outdated information from the memories of appliances which remain in system 100, and removing information from the removed component, are also within the scope of the present invention.

Networked appliance can also use their connection to the Internet to provide additional resources to a user. For example, a user may want a specific picture resident on DiVSA 106 to be printed professionally, placed in a preselected frame and delivered to a family member. In this case personal computer 105 may access the preselected universal resource locator (URL) of an appropriate service bureau capable of processing the picture, order the frame, request DiVSA 106 to transfer the digital image to the service bureau at the identified URL for printing and framing, and request PDA 101 to supply the service bureau with the address of the family member to which the completed picture is to be sent. In this example each of the networked appliances individually communicates with the URL through home gateway 109.

Information transfer between appliances may be initiated by the user using, for instance, a scroll list of other available networked appliances, or by the occurrence of a predetermined event. For instance, the user can instruct a digital camera (not shown) to download new images acquired since a previous download whenever the digital camera is within range of DiVSA 106, assuming DiVSA 106 is available for the download. If DiVSA 106 is not available for the download at the time the digital camera is within range, the digital camera could continue to try to complete the download until such time as DiVSA 106 becomes available and a download accomplished.

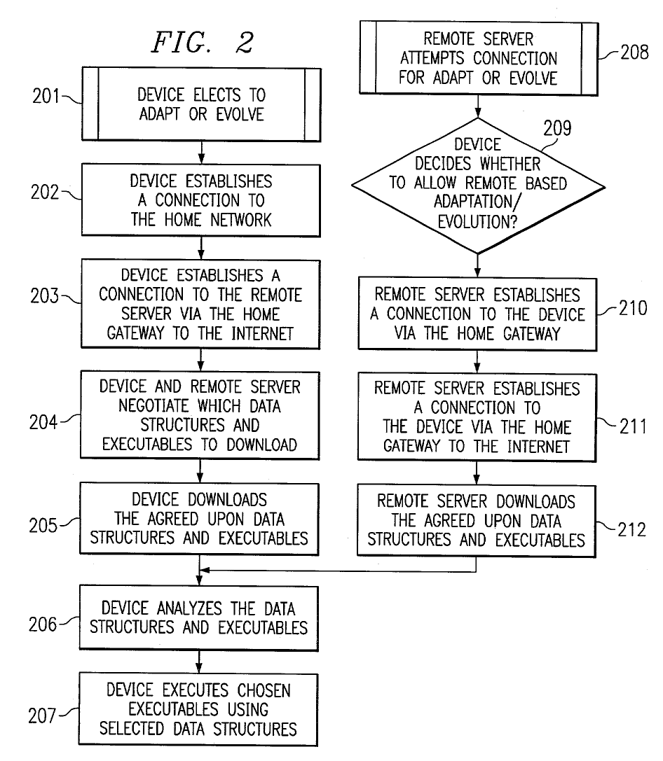

FIG. 2 illustrates a process flow chart according to one embodiment of the invention. The flow chart shows various methods in which the software resident on a network appliance can be updated. At step 201 a specified networked appliance is scheduled to check to see whether updated software is available. This process may be initiated upon the occurrence of a specified event (e.g., an error condition attributable to software incompatibility etc.) or may occur periodically throughout the life of the networked appliance. For example, updates may be scheduled for a specific day each month or year, or may occur through the implementation of a timeout feature within the networked appliance which initiates a check for updated software after every 25th startup. Once the determination has been made that the network appliance is scheduled to check for updated software, the appliance establishes a connection to the home network at step 202. Once established, the network appliance extends the connection to a home gateway 109 to allow the network appliance to access remote server 108 via, for instance modem 113 in step 203. At this point the network appliance coordinates with remote server 108 to determine whether updated software is available to the networked appliance at step 204. This determination may be made in a number of ways including access to a manufacturer's website to determine whether updated software is available. If a website is checked, the network appliance may have been shipped, for example, with a URL associated with information resident. If updated software is available, the network appliance downloads the updated software at step 205 and analyzes the data received during the download at step 206. After the network appliance determines the software is the appropriate software for the device, the device executes the download software and updates its executables.

Similarly, remote server 108 may also execute software which determines that software updates are required for networked appliances which access the remote server. This process begins in step 208 of FIG. 2. One method of identifying networked appliances which require updates is for remote server 108 (FIG. 1) to periodically check specific websites which contain device types for which updated software is available. Once remote server 108 identifies that updated software is available, the specific affected network appliance is notified and the device determines whether it should update its software at step 209. If the networked appliance determines its software should be updated, remote server 108 establishes a connection with the appropriate networked appliance at step 210 and uses the Internet to access and retrieve the updated software at step 211. Once the connection is established and the updated software is identified, remote server 108 downloads the required files at step 212. These updated software programs or instructions are made available to the networked appliance at step 206 and, at step 207 the device executes the appropriate executables to update its software.

According to a preferred embodiment a system implementing the invention may include peer to peer network appliances which can communicate with any other network appliance via wireless communications without personal computer oversight. An embodiment may also include automatic reconfiguration of the network for addition or removal of devices from the networked appliances. Additionally, networked appliances may automatically update shared data.

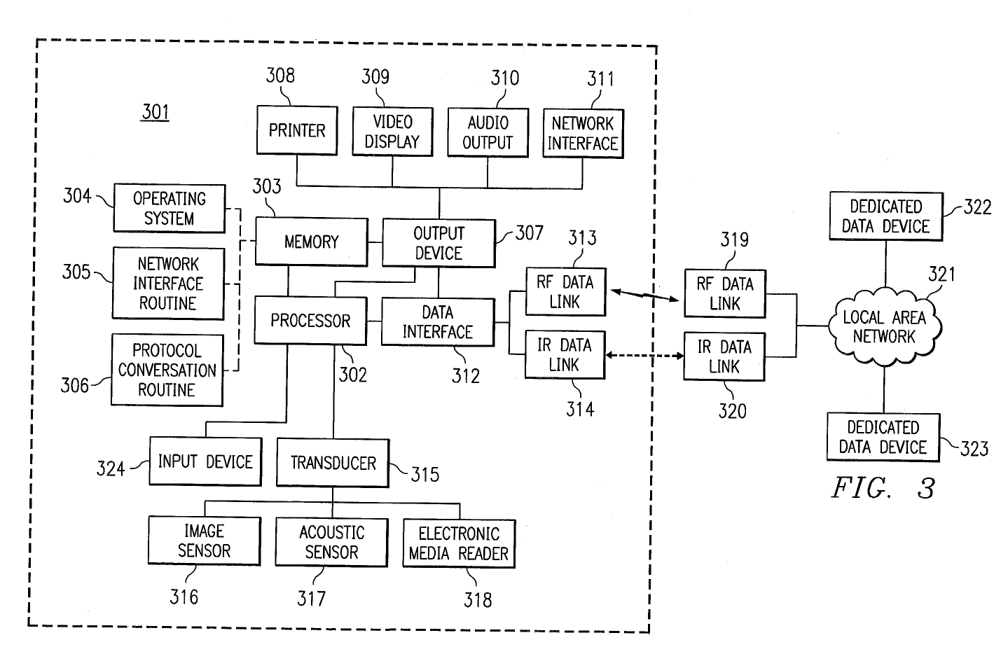

FIG. 3 is a block diagram of a network appliance 301 according to an embodiment of the invention showing details of the appliance and its interface with other dedicated data devices. In particular, network appliance 301 includes a processor 302 connected to memory 303. Processor 302 may be a general purpose microprocessor or, more typically, a dedicated processor such as an application specific integrated circuit (ASIC). Memory 303 may be a nonvolatile memory such as EPROM, EEPROM, ROM, etc., or may be volatile such as RAM, SRAM, or DRAM requiring the loading of software upon system start-up. Memory 303 is capable of storing a variety of software and data including, for example, operating system 304, network interface routine 305 and protocol conversion routine 306. However, at least a portion of memory 303 may be dedicated to and store an appropriate application-specific routine to provide network appliance 301 its primary functionality. For example, in the case of a digital camera, at least a portion of memory 303 is dedicated to camera operations. Typically, the application-specific routine would consume most, if not all, of the available program and/or data memory resources. The dedication portion of memory may permanently store the application-specific routine when nonvolatile memory is used or the application-specific routine may be loaded into memory at system start-up. Thus, protocol conversion routine 306 may be executed by processor 302 so as to convert between data formats as required to effectuate a data transfer with a remote dedicated data device. In particular, protocol conversion routine 306 operates to convert a first data format corresponding to a native data format of the network appliance to and/or from a second data format corresponding to a native data format of the dedicated data device. These routines as stored in memory 303 are executed by processor 302 to provide required functionality of the device. In addition, other functionality in support of the device may be included and stored in memory 303.

Network appliance 301 further includes an output device 307 in the form of, for example, printer 308, video display 309, audio output device 310 and/or network interface 311. Video display 309 in combination with processor 302 may provide an indication of a particular dedicated data device which is in communication with network appliance 301 so as to allow selection by a user of the dedicated data device and to initiate a data transfer therewith. Output device 307 may interface directly with memory 303 to provide direct memory access. Further, output device 307 connects to processor 302 for processor supervised input/output processing.

Network appliance 301 may further include an input device 324 such as a keyboard, touch panel, buttons and switches or other means for a user to select options and provide for control. Further providing an input to processor 302 and network appliance 301 are one or more transducers 315. Transducer 315 may include, for example, an image sensor 316 such as may be provided for a digital camera; an acoustic sensor 317 as provided by an audio input device; or an electronic media reader 318 such as an MP3 player.

Interfacing network appliance 301 with other devices is data interface 312. Data interface 312 may be wired or, more preferably, a wireless data link such as RF data link 313 and/or IR data link 314. These links may communicate with corresponding respective RF data link data link 319 and IR data link 320 to provide connectivity with local area network 321. In turn, local area network 321 provides connectivity to dedicated data devices 322 and 323. Further, remote communications capability with other devices may be provided by interfaces with a remote server or appliance (not shown) as previously discussed in connection with FIG. 1.

Note that, although the network appliance 301 depicted in FIG. 3 is shown including a wide variety of both transducers for inputting data and output devices for supplying data to a user, it is expected that only a small portion of such devices would be included as part of any particular network appliance. That is, the variety of capabilities, functionalities and structures depicted in FIG. 3 are for purposes of illustration only so as to provide an understanding of the type of structures which may be included within and as part of a particular network appliance. Instead, it is expected that any one network appliance and/or dedicated data device would function primarily to either input or be a source of data (e.g. a digital camera) or a data recipient (e.g., a printer).

What is claimed is:

1. A network appliance comprising:
a memory dedicated to and storing an application-specific routine;
a data interface to a local area network; and
a controller dedicated to execute said application-specific routine to process data in said memory,
execute a network interface routine to interface with said local area network using said data interface and identify a type and address of a dedicated data device resident on said local area network, and
exchange data between said memory and said dedicated data device.

2. The network appliance according to claim 1 further comprising a transducer responsive to an external stimulus for storing data corresponding to a characteristic of said external stimulus into said memory, said controller configured to upload said data to said dedicated data device.

3. The network appliance according to claim 2 wherein said transducer comprises one of an image sensor, an acoustic sensor and a specialized electronic media reader.

4. The network appliance according to claim 1 further comprising an output device configured to receive said data from said memory, said controller configured to download said data from said dedicated data device.

5. The network appliance according to claim 4 wherein said output device comprises one of a printer, a video display, an audio output device, and an interface to a remote network.

6. The network appliance according to claim 1 wherein said controller comprises an application-specific integrated circuit.

7. The network appliance according to claim 1 wherein said data interface comprises a wireless data transceiver.

8. The network appliance according to claim 7 wherein said wireless transceiver transmits and receives using one of a radio frequency (RF) and infrared (IR) communication link.

9. The network appliance according to claim 1 further comprising a display configured to provide an indication of said dedicated data device and an input device configured to provide for a manual selection to initiate a data transfer with said dedicated data device.

10. The network appliance according to claim 1 further including an application-specific operating system stored in said memory, said controller further executing said application-specific operating system.

11. The network appliance according to claim 1 further comprising a protocol conversion routine for converting between a first data format corresponding to a native data format of said network appliance and a second data format corresponding to a native data format of said dedicated data device.

12. A system of network appliances, comprising:
a communications network; and
a plurality of network appliances, each including:
a data interface with a local area network;
a memory dedicated to and storing an application-specific routine; and
a controller dedicated to:
execute an application-specific routine to process data,
execute a network interface routine to interface with said local area network using said data interface and identify a type and address of at least another one of said network appliances on said communications network, and
exchange said data with said other network appliance over said communications network.

13. The system of network appliances according to claim 12 wherein said communications network comprises a wireless local area network.

14. The system of network appliances according to claim 12 wherein said data interfaces comprise respective wireless data transceivers.

15. The system of network appliances according to claim 12 wherein:
each of a first group of said network appliances further comprises a dedicated input device configured to receive information; and
each of a second group of said network appliances further comprises a dedicated output device configured to generate a representation of said data onto an output media.

16. The system of network appliances according to claim 12 wherein each of said network appliances further comprises a protocol conversion routine for converting between a first data format corresponding to a native data format of said each network appliance and a second data format corresponding to another one of said network appliances.

17. A method of transferring data between first and second network appliances, comprising the steps of:
establishing communications with a local area network;
registering with said local area network;
identifying resources available on said local area network;
identifying ones of said resources satisfying predetermined compatibility criteria;
establishing communications with a selected one of said resources satisfying said predetermined compatibility criteria; and
exchanging data with said selected resource.

18. The method of claim 17 further comprising the steps of displaying said ones of said resources satisfying said predetermined compatibility criteria and selecting said one of said resources.

19. The method of claim 17 further comprising the steps of identifying a data format of said selected resource and converting between a different data format and said data format of said selected resource.

20. The method of claim 17 wherein said step of establishing communications includes steps of creating a wireless communications link between said first network appliance and said local area network and creating a wireless communications link between said local area network and said second network appliance.
